(19) United States
(12) Patent Application Publication
(10) Pub. No.: US 2003/0044161 A1
(43) Pub. Date: Mar. 6, 2003

(54) Output device with select means

(75) Inventor: Michael Kandler, Vienna (AT)

Correspondence Address: Corporate Patent Counsel, U.S Philips Corporation, 580 White Plains Road, Tarrytown, NY, 10591, US

(73) Assignee: KONINKLIJKE PHILIPS ELECTRONICS N.V.

(21) Appl. No.: 10/227,716

(22) Filed: Aug. 26, 2002

(30) Foreign Application Priority Data
Aug. 31, 2001 (EP) 01 890 258.5

(51) Int. Cl. H04N 5/76

(52) U.S. Cl. 386/46; 386/96

(57) ABSTRACT

In the case of an output device (1) for direct output or for storage and deferred output of received audio (EAI) and video (EVI) television program data, having receiving means (3) for receiving the audio (EAI) and video (EVI) data and having memory means (11) for storing the received audio (EAI) and video (EVI) data, the memory means (11) allowing simultaneous storage of the received audio (EAI) and video (EVI) data and read-out of previously stored audio (WAI) and video (WVI) data, and having selection means (4, 5, 17, 18) for selecting audio (AAI) and video (AVI) data to be output and having output means (17, 18) for outputting the audio (AAI) and video (AVI) data to be output, in order to allow visual playback of the video data (AVI) and acoustic playback of the audio data (AAI), wherein the selection means (4, 5, 17, 18) are designed to select the video data (EVI) currently being received with the audio data (WAI) received and stored a back period (TR) ago or to select the video data (WVI) received and stored a back period (TR) ago with the audio data (EAI) currently being received as audio (AAI) and video (AVI) data to be output.

The invention relates to an output device for direct output or for storage and deferred output of received audio and video television program data, having receiving means for receiving the audio and video data and having memory means for storing the received audio and video data, the memory means allowing simultaneous storage of the received audio and video data and read-out of previously stored audio and video data, and having selection means for selecting audio and video data to be output and having output means for outputting the audio and video data to be output, in order to allow visual playback of the video data and acoustic playback of the audio data.

The invention further relates to an output method for direct output or for storage and deferred output of received audio and video television program data, wherein the following steps are executed:

reception of the audio and video data;

storage of the received audio and video data, wherein simultaneous storage of the received audio and video data and read-out of previously stored audio and video data are possible;

selection of audio and video data to be output;

output of the audio and video data to be output, in order to allow visual playback of the video data and acoustic playback of the audio data.

The applicant has made commercially available a hard disk recorder of the type TiVo HDR312, which constitutes an output device. The known hard disk recorder includes a tuner, with which audio and video television program data may be received and output to a television set connectable to the hard disk recorder. The hard disk recorder memory means include a hard disk with a storage capacity of 27 Gbytes for storing audio and video data from received television programs, with which stored television programs may be played back over a playback period of up to 30 hours.

The known hard disk recorder comprises selection means for selecting from audio and video data to be output to the television set, which include a hard disk recorder remote control. By remote control, the user may select the audio and video data currently being received by the tuner or the audio and video data stored on the hard disk for output to the television set and playback by the television set.

The known hard disk recorder comprises a so-called “Pause Live TV” feature, with which it is possible for the user of the hard disk recorder to view a whole television program although the user is disturbed during viewing thereof, for example by an incoming telephone call. If the user is disturbed when viewing the television program currently being received, the user actuates a pause button on the selection means, whereupon the recording mode of the hard disk recorder is activated. If the user wishes to continue viewing the television program once the telephone call is finished, he/she again presses the pause button, whereupon the audio and video data of the television program stored for the user on the hard disk from the time of the interruption are played back. This feature is made possible in that, after reactuation of the pause button by the user, the audio and video television program data currently being received are stored on the hard disk and at the same time the audio and video television program data stored a few minutes previously are read out from the hard disk.

In the case of the known hard disk recorder and the known method, the disadvantage has been revealed that the user does not have the option of watching again some scenes of a television program currently being received, such as for example a sports transmission or a news broadcast, without losing the “live” nature of the television program and thus the advantage of up-to-the-minute information.

It is an object of the invention to provide an output device of the type indicated in the first paragraph and an output method of the type indicated in the second paragraph, with which the above-mentioned disadvantages are avoided.

To achieve the above-indicated object, in the case of an output device according to the invention the selection means are designed to select as the audio and video data to be output the video data currently being received with the audio data received and stored prior to a back period or the video data received and stored prior to the back period with the audio data currently being received.

To achieve the above-indicated object, in the case of an output method according to the invention it is possible to select as the audio and video data to be output the video data currently being received with the audio data received and stored prior to a back period or the video data received and stored prior to the back period with the audio data currently being received.

In this way, it is ensured that the user may for example, by actuating the selection means, watch again the preceding scene of the television program currently being received while at the same time listening to the audio data currently being received. This allows the user to turn back to the video data currently being received, if the audio data currently being received suggests that an important scene of the television program is currently being received.

If, for example, the user is watching a soccer match and would like to watch again the scene just viewed, in which a goal was scored, without missing any further goal scored within the next minute, he may, by actuating the selection means, view the video data of the goal scene stored using the memory means and at the same time listen to the audio data currently being received. If the user recognizes from the audio data that an interesting scene is unfolding at that precise moment, he may turn back and continue to view the television program currently being received.

Likewise, it is possible, by actuating the selection means, to listen again to the audio data of the preceding scene of the television program currently being viewed and at the same time to view the video data currently being received. This may be of interest to the user for instance in the case of a news broadcast, if the user wants to listen again to the temperatures just quoted by the speaker for the next day while at the same deciding on the basis of the video data currently being received and displayed by the television set whether the news article currently being received is of greater interest to him/her. If the article currently being transmitted is indeed interesting, the user may turn back immediately and watch the audio and video data of the article currently being received.

According to the measures of claim 2 and claim 10, the advantage is achieved that the output device or an output device remote control comprises a back button, by actuation of which the back period may be selected. Thus, for example, brief actuation of the back button may select a back period of 5 seconds and longer actuation of the back button may select a back period of 20 seconds.

According to the measures of claim 3, the advantage is achieved that, for example by single actuation of the back button, the video data received 20 seconds previously is output by the output device together with the audio data currently being received.

According to the measures of claim 4 and claim 11, the advantage is achieved that, for example by actuating the back button three times, the video data received 60 seconds previously is output by the output device together with the audio data currently being received.

According to the measures of claim 5, the advantage is achieved that, by single actuation of a forward button, it is possible particularly to swap quickly back to the output of the audio and video data currently being received.

According to the measures of claim 6, the output device comprises especially advantageous memory means.

According to the measures of claim 7, the advantage is achieved that the output device is accommodated in the same housing as the monitor for playing back the video data and the loudspeaker for playing back the audio data.

According to the measures of claim 8 and claim 12, the advantage is achieved that, once the selected back period has passed, playback automatically returns to the picture and sound of the television program currently being received. In this way, the user sees or hears the desired scene again during the selected back period, whereupon playback then switches automatically back to the television program currently being received.

The invention will be further described with reference to an example of embodiments shown in the drawings, to which, however, the invention is not restricted.

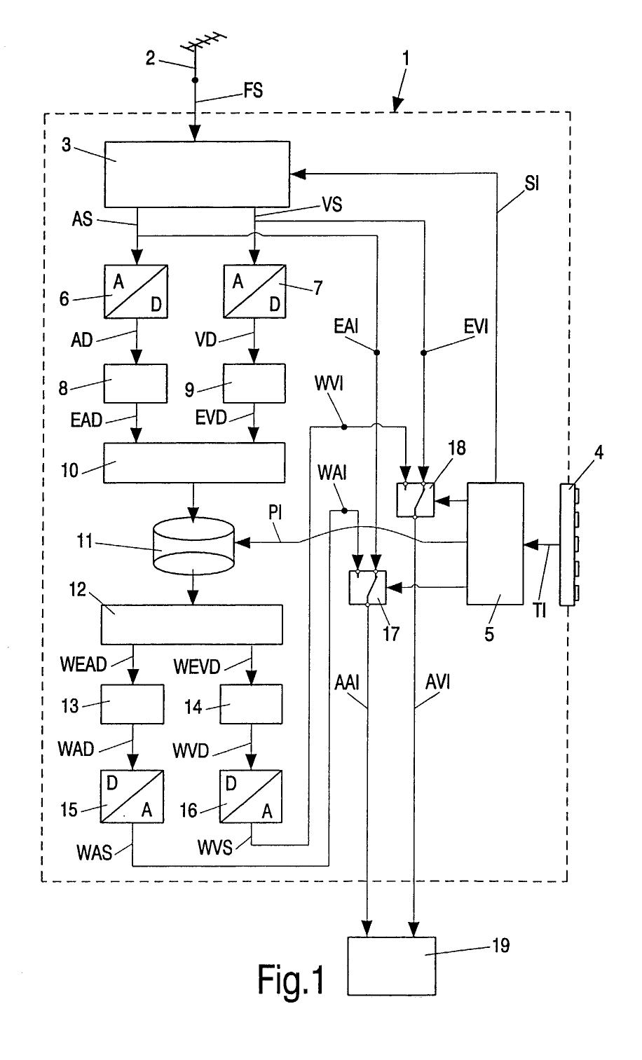

FIG. 1 shows a hard disk recorder for storing received audio and video data and for outputting stored audio and video data.

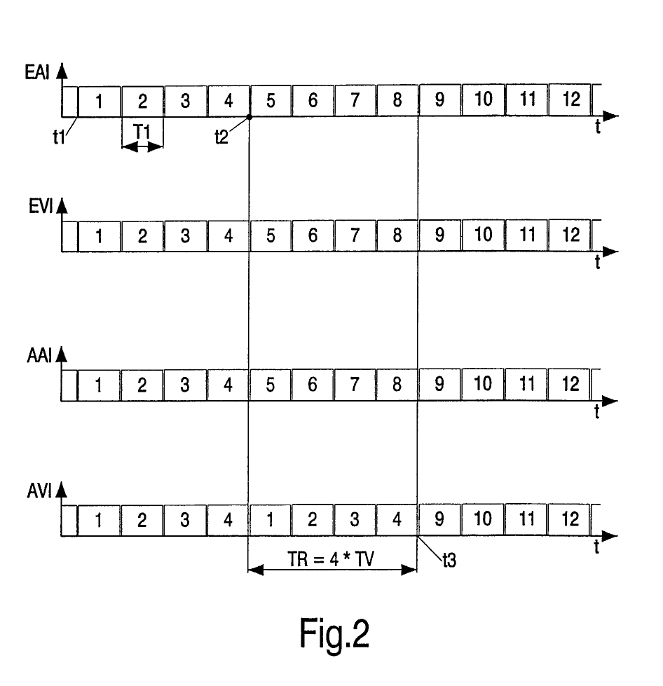

FIG. 2 shows time profiles for the audio and video data received and output by the hard disk recorder according to FIG. 1.

FIG. 1 shows a hard disk recorder 1, which constitutes an output device for direct output or for storage and deferred output of audio and video television program data and performs a corresponding output method. An aerial 2 is connected to the hard disk recorder 1, from which aerial a television signal FS received by the aerial 2 may be sent to a tuner 3 of the hard disk recorder 1. The received television signal FS contains audio and video television program data in reception channels.

The hard disk recorder 1 further comprises a keypad 4 and a control stage 5. A user of the hard disk recorder 1 may activate operating modes of the hard disk recorder 1 by actuating buttons on the keypad 4 and in so doing also select the reception channel to be received by the tuner 3, on which the audio and video data of a particular television broadcaster may be received. Keypad data TI corresponding to the reception channel may be sent by the keypad 4 to the control stage 5, which sends corresponding control data SI to the tuner 3.

The tuner 3 is designed to process the received television signal FS and to output an analog audio signal AS which contains received audio data EAI, received on the selected reception channel, and to output an analog video signal VS, which contains received video data EVI, received on the selected reception channel.

The hard disk recorder 1 additionally comprises two A/D converter stages 6 and 7. The analog audio signal AS may be fed to the A/D converter stage 6 and digital audio data AD containing the received audio data EAI may be sent by the A/D converter stage 6 to an audio encoder stage 8. The analog video signal VS may be fed to the A/D converter stage 7 and digital video data VD containing the received video data EVI may be sent by the A/D converter stage 7 to a video encoder stage 9.

The audio encoder stage 8 is designed to encode the digital audio data AD and to output encoded audio data EAD and the video encoder stage 9 is designed to encode the digital video data VD and to output encoded video data EVD, as has long been known. The encoded audio data EAD and the encoded video data EVD may be fed to a multiplexer stage 10 of the hard disk recorder 1.

The hard disk recorder 1 additionally comprises a hard disk stage 11, which constitutes the memory means for storing the received audio data EAI and video data EVI. When the hard disk recorder 1 is in memory mode, the encoded audio data EAD and encoded video data EVD output continuously by the multiplexer stage 10 may be buffered using an input buffer stage of the hard disk stage 11 and stored by the input buffer stage using a hard disk of the hard disk stage 11 during hard disk storage cycles. When the hard disk recorder 1 is in playback mode, encoded audio data WEAD and encoded video data WEVD read out in hard disk read cycles may be buffered in an output buffer stage of the hard disk stage and output continuously thereby.

In simultaneous mode, the hard disk stage 11 is designed for simultaneous storage of the encoded audio data EAD and encoded video data EVD and read-out of previously stored and read-out encoded audio data WEAD and encoded video data WEVD, as is known generally for random access memory means. In this way, for example, a generally known “Pause Live TV” feature is made possible, in which the hard disk recorder 1 stores the received audio data EAI and video data EVI of a television program using the hard disk stage 11 and at the same time outputs the audio data WAI and video data WVI of the television program stored for example 10 minutes previously using the hard disk stage 11 and then read out.

The hard disk recorder 1 additionally comprises a demultiplexer stage 12, an audio decoder stage 13, a video decoder stage 14, a D/A converter stage 15 and a D/A converter stage 16, in order to be able, when the hard disk recorder 1 is in playback and simultaneous mode, to output encoded audio data WEAD and encoded video data WEVD read out using the hard disk stage 11 as read-out analog audio signal WAS and video signal WVS containing the read-out audio data WAI and video data WVI.

At the same time, the demultiplexer stage 12 is designed to separate the encoded audio data WEAD and encoded video data WEVD read out from the hard disk stage 11, the audio decoder stage 13 is designed to decode the read-out encoded audio data WEAD and the video decoder stage 14 is designed to decode the read-out encoded video data WEVD. The D/A converter stages 15 and 16 are designed to convert the read-out digital audio data WAD and video data WVD into the read-out analog audio signal WAS and analog video signal WVS, which contain the read-out audio data WAI and video data WVI.

The hard disk recorder 1 additionally comprises selection means for selecting audio data AAI and video data AVI to be output by the hard disk recorder 1. The selection means consist of the keypad 4, the control stage 5 and a first selection switch 17 and a second selection switch 18.

Both the analog audio signal AS containing the received audio data EAI and the read-out analog audio signal WAS containing the read-out audio data WAI may be fed to the first selection switch 17. Depending on the switch position of the first selection switch 17, the received analog audio signal AS or the read-out analog audio signal WAS may be output by the first selection switch 17 as an analog audio signal containing the output audio data AAI.

Both the analog video signal VS containing the received video data EVI and the read-out analog video signal WVS containing the read-out video data WVI may be fed to the second selection switch 18. Depending on the switch position of the second selection switch 18, the received analog video signal VS or the read-out analog video signal WVS may be output by the second selection switch 18 as an analog video signal containing the output video data AVI.

The first selection switch 17 and the second selection switch 18 also form output means for outputting the audio data AAI and video data AVI to be output, in order to allow visual playback of the output video data AVI and acoustic playback of the output audio data AAI. For this purpose, the analog audio signal output by the first selection switch 17 and the analog video signal output by the second selection switch may be fed to a television set 19.

The user of the hard disk recorder 1 may select, by actuating a button on the keypad 4, whether he/she would like to watch on the television set 19 a television program currently being received by the tuner 3 or a television program played back by the hard disk stage 11. In accordance with the user's selection, the selection switches 17 and 18 are directed by the control stage 5 either into the first switch position (shown in FIG. 1), whereupon the sound and picture of the television program currently being received are played on the television set 19, or into the second switch position, whereupon the sound and picture of the television program read out from the hard disk stage 11 in playback mode or simultaneous mode are played back using the television set 19.

The selection means of the hard disk recorder 1 are additionally designed, when the hard disk recorder 1 is in back mode, to select the video data EVI currently being received with the audio data WAI received and stored a back period TR ago and currently being read out or to select the video data WVI received and stored a back period TR ago and currently being read out with the audio data EAI currently being received as audio data AAI and video data AVI to be output. To this end, the selection switches 17 and 18 are directed into respectively different switch positions by the control stage 5. The following example of application of the hard disk recorder 1 is used to describe in more detail, with reference to FIG. 2, the manner of operation of the back mode and the advantages thereof.

According to the example of application, it is assumed that the user of the hard disk recorder 1 is watching a news program broadcast by the television broadcaster CNN. To this end, the user has actuated the appropriate button on the keypad 4, in order to direct the selection switches 17 and 18 into their first switch positions, whereupon the received audio data EAI and the received video data EVI of the news broadcast are output by the hard disk recorder 1 to the television set 19 as audio data AAI to be output and video data AVI to be output. The received audio data EAI and received video data EVI is additionally stored using the hard disk stage 11, as explained above.

FIG. 2 shows the audio data EAI and video data EVI received by the tuner 2 of the hard disk recorder 1 and the audio data AAI and video data AVI output by the hard disk recorder 1. The audio and video data contained in the analog audio signals and video signals are illustrated in data blocks, each of a duration T1 of 5 seconds. Such division serves solely to simplify the illustration and explanation of the audio and video data received and output by the hard disk recorder 1 and has no further technical significance.

According to the example of application, it is further assumed that the user sees an interesting scene in the news broadcast, but misses the essential information accompanying this scene. For example, the user could have been watching the weather report currently being transmitted, and missed the morning temperatures for his/her state. Likewise, the user could have observed that the lotto numbers had just been displayed, but that he had missed them and would liked to have written them down.

It is assumed that some such interesting scene is contained in the audio data EAI and video data EVI received from a time t1 to a time t2 and therefore lasted 20 seconds. The user notes at the time t2 that he/she has missed the lotto numbers, for example, and decides that he/she would like to view this interesting, approximately 20 second scene again. To this end, the user presses a back button on the keypad 4 four times.

By pressing the back button, the back mode is activated in the hard disk recorder 1 and the control stage 5 determines the back period TR=20 seconds desired by the user by multiplying the number of times the back button was pressed by a preset back period TV of 5 seconds, which corresponds in this example to the block length T1, for the sake of simplicity. Then, position information PI is sent to the hard disk stage 11 by the control stage 5, which position information PI identifies a readout position at which the audio data EAI and video data EVI received 20 seconds before the time t2, i.e. at time t1, was stored.

When the back mode has been activated in the hard disk recorder 1, the control stage 5 directs the first selection switch 17 into its first switch position 18 and the second selection switch 18 into its second switch position. In this way, it is ensured that, in back mode, the audio data EAI currently being received are output together with the video data WVI played back from the hard disk stage 11. Thus, from the time t2, the played-back video data WVI are output as output video data AVI which correspond to the received video data EVI of the blocks 1 to 4, as shown in FIG. 2.

In this way, it is ensured that the user may watch the last scene again in accordance with the selected back period TR, while at the same time hearing the sound currently being received. In this way, it is advantageously ensured that the user may on the one hand note down the lotto numbers displayed in the scene and on the other hand hear what news article is currently being broadcast.

The control stage 5 is further designed automatically to select the audio data EAI and video data EVI currently being received as the audio data AAI and video data AVI to be output, when the selected back period TR has passed since the back button was pressed. To this end, at a time t3 at which the blocks 1 to 4 of the repeated scene have already been played back, the control stage 5 directs both the first selection switch 17 and the second selection switch 18 into their first switch positions.

In this way, the advantage is achieved that the hard disk recorder 1 automatically terminates back mode after playback of the scene missed by the user and resumes output of the received audio data EAI and video data EVI as output audio data AAI and video data AVI.

Of particular advantage is the fact that, by pressing the back button four times, the user may particularly simply select four times the preset back period TV, i.e. the back period RT of 20 seconds.

It is additionally advantageous that the user may change the preset back period TV manually. For example, the user may be interested in repeating scenes with a back period TR of at least 30 seconds. In this case, the user may manually set a preset back period TV=30 seconds, whereby the back period TR=30 seconds would advantageously be selected by pressing the back button just once.

The user may, when the back mode is activated in the hard disk recorder 1, decide on the basis of the sound heard whether, through repeating the last scene, he/she is missing a scene currently being received which may be even more interesting and would like to terminate back mode. For example, the user could hear that a quiz question is being posed and a prize offered in return for ringing a superimposed telephone number and answering the quiz question correctly. However, there is only any point in this if the call is made immediately, as otherwise the telephone line is sure to be already engaged. Advantageously, the user may in such a case immediately terminate back mode manually by pressing a forward button on the keypad 4, whereby the audio data EAI and video data EVI currently being received are immediately output again as output audio data AAI and video data AVI.

Similarly, by pressing another button on the keypad 4, the user could obtain output of the played back audio data WAI over the video data WVI already being played back. This is particularly advantageous if the user would like to play back both the sound and the picture of the scene in back mode.

It may be mentioned that a wide range of random access storage media is known to the person skilled in the art. Of particular advantage is the use of a hard disk or a rewritable DVD (DVD+RW).

It may be mentioned that, when the hard disk recorder is in back mode, the video data EVI currently being received could also be output as video data AVI to be output together with the played-back audio data WAI as audio data AAI to be output. In this case, the user would thus hear the sound of the missed scene again, while continuously viewing the pictures of the television program currently being received. This may be advantageous, for example, when the user only wishes to hear again the missed temperatures from the weather report or lotto numbers spoken by the television presenter. Advantageously, it would be possible to switch between these two back modes manually by pressing a button on the keypad.

It may be mentioned that an output device according to the invention could likewise receive a digital television signal which contains audio and video data in digital format. Likewise, the audio and video data to be output could be output in digital format. For example, an output device could thus take the form of a DVD+RW device.

It may be mentioned that, in back mode, a plurality of successive scenes with a back period TR=10 minutes, for example, or even an hour could be viewed again.

It may be mentioned that the user of the hard disk recorder 1 according to the invention could also be used in such a way that he/she views in back mode the played-back video data WVI of a film recorded a week ago, while simultaneously listening to the audio data EAI currently being received, in order, for example, to be able to switch over to the video data EVI currently being received exactly when a particular film starts. In this example, it is thus possible to swap in back mode from output of the played-back audio data WAI and played-back video data WVI to output of the audio data EAI currently being received and the played-back video data WVI. The back period is thus also to be understood as a back period with a negative value, i.e. as a forward period.

1. An output device (1) for direct output or for storage and deferred output of received audio and video television program data (EAI, EVI), having
receiving means (3) for receiving the audio and video data (EAI, EVI) and having
memory means (11) for storage of the received audio and video data (EAI, EVI), wherein the memory means (11) allow simultaneous storage of the received audio and video data (EAI, EVI) and read-out of previously stored audio and video data (WAI, WVI), and having
selection means (4, 5, 17, 18) for selection of the audio and video data (AAI, AVI) to be output and having
output means (17, 18) for output of the audio and video data (AAI, AVI) to be output, in order to allow visual playback of the video data (AVI) and acoustic playback of the audio data (AAI),
characterized in that the selection means (4, 5, 17, 18) are designed to select the video data (EVI) currently being received with the audio data (WAI) received and stored a back period (TR) ago or to select the video data (WVI) received and stored a back period (TR) ago with the audio data (EAI) currently being received as audio and video data (AAI, AVI) to be output.

2. An output device (1) as claimed in claim 1, characterized in that the selection means (4, 5, 17, 18) comprise a manually actuatable back button, with which the back period (TR) may be selected.

3. An output device (1) as claimed in claim 2, characterized in that a preset back period (TR) may be selected by pressing the back button once.

4. An output device (1) as claimed in claim 3, characterized in that K times the preset back period (TR) may be selected by pressing the back button K times.

5. An output device (1) as claimed in claim 1, characterized in that the selection means (4, 5, 17, 18) comprise a manually actuatable forward button, with which the audio and video data (EAI, EVI) currently being received may be selected as audio and video data (AAI, AVI) to be output.

6. An output device (1) as claimed in claim 1, characterized in that the memory means (11) contain a hard disk or a DVD+RW.

7. An output device (1) as claimed in claim 1, characterized in that the output device (1) comprises a monitor and a loudspeaker, which are connected with the output means (17, 18).

8. An output device (1) as claimed in claim 1, characterized in that the selection means (4, 5, 17, 18) are designed automatically to select the audio and video data (EAI, EVI) currently being received as audio and video data (AAI, AVI) to be output, if the selected back period (TR) has passed since the back button was pressed.

9. An output method for direct output or for storage and deferred output of received audio and video television program data (EAI, EVI), wherein the following steps are executed:
reception of the audio and video data (EAI, EVI);
storage of the received audio and video data (EAI, EVI), wherein simultaneous storage of the received audio and video data (EAI, EVI) and read-out of previously stored audio and video data (WAI, WVI) are possible;
selection of audio and video data (AAI, AVI) to be output;
output of the audio and video data (AAI, AVI) to be output, in order to allow visual playback of the video data (AVI) and acoustic playback of the audio data (AAI), wherein additionally
it is possible to select the video data (EVI) currently being received with the audio data (WAI) received and stored a back period (TR) ago or the video data (WVI) received and stored a back period (TR) ago with the audio data (EAI) currently being received as audio and video data (AAI, AVI) to be output.

10. An output method as claimed in claim 9, wherein the back period (TR) may be manually selected.

11. An output method as claimed in claim 10, wherein a single preset back period (TR) or K times the preset back period (TR) is selected by pressing a back button once or K times.

12. An output method (10) as claimed in claim 10, wherein the audio and video data (EAI, EVI) currently being received are automatically selected as audio and video data (AAI, AVI) to be output, if the selected back period (TR) has passed since the back button was pressed.
